(19) United States
(12) Patent Application Publication
(10) Pub. No.: US 2009/0095851 A1
(43) Pub. Date: Apr. 16, 2009

(54) Vertical pole support system

(76) Inventor: Josephine G. Stolworthy, Los Lunas, NM (US)

Correspondence Address: ORTIZ & LOPEZ, PLLC, P.O. BOX 4484, ALBUQUERQUE, NM, 87196-4484, US

(21) Appl. No.: 11/973,651

(22) Filed: Oct. 10, 2007

(51) Int. Cl. F16M 13/00; F16B 7/10; F16L 3/00

(52) U.S. Cl. 248/125.8; 248/121; 403/109.1

(57) ABSTRACT

A portable medical balance and support apparatus and its use as a system is disclosed which includes a telescoping bar which is fitted with end-caps and an extension and retraction module. The apparatus includes a grip fitted to the bar to facilitate its use as a balance and support aid. The apparatus is intended to be portable. A user may set up the apparatus by placing one end-cap on the floor of a dwelling and then operating the extension and retraction module, which may be configured of a crank, a pneumatic actuator, an electric motor or a detent mechanism, to extended the vertical telescoping bar so that the top end-cap is pressed against the ceiling of the dwelling and the apparatus is secured between the floor and ceiling. After the apparatus has been used the extension and retraction module is used again to retract the telescoping bar and the apparatus can be moved to a different location.

### TECHNICAL FIELD

Embodiments are generally related to devices and systems for aiding those who require assistance in maneuvering around the house in day to day activities. Embodiments are also related to apparatuses and systems to assist people with medical conditions which limit their ability to stand and move about without assistance.

### BACKGROUND OF THE INVENTION

Support rails are commonly provided in hospitals, assisted living facilities, and other residences for disabled people who use support rails to move themselves about.

Although there are many types of support rails, they are all commonly attached to walls, floors or any other convenient support surface, usually with screws or some other fastening device (See for example Breen U.S. Pat. No. 3,633,862). Consequently, when the rail is installed it is semi-permanent and inconvenient to move to another location. As a result, a patient requiring support rails in more than one place in a dwelling must install separate rails in all the places where such rails may be needed. In addition, the installation of a support rail generally requires fastening devices which can leave unwanted mounting holes in the surface to which the rail is mounted.

A similar problem arises when installing support rails commonly known as “grab bars”. These consist of a rail having angled end portions and end pieces for connection to a wall. Installation of grab bars requires specific orientation depending on the desired angle of the bar. Consequently, a large variety of bars may be required depending on factors such as the location of the bar in the house or the proximity of the bar to surfaces adequate for mounting.

The present invention solves these problems by offering a simple and effective means of engaging and disengaging a support rail without the use of fasteners. Thus, the apparatus can be moved about the house quickly and can be used in places where a classic safety rail or grab bar might not otherwise be available.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is therefore, one aspect of the present invention to provide an improved support rail or grab bar apparatus and system.

It is another aspect of the present invention to provide an improved portable support rail or grab bar apparatus and system.

The aforementioned aspects of the invention and other objectives and advantages can now be achieved as described herein. A portable medical balance and support apparatus and system are disclosed herein, which offer a person in need of a safety rail or grab bar the convenience of having such a bar anywhere in the house without the hassle and expense of installing multiple safety rails and grab bars all over the residence. The portable medical balance and support apparatus is generally configured from a vertical telescoping metal bar, a set of soft end-caps, and an extension and retraction module. The vertical telescoping bar is generally configured from two bars one of which has a slightly smaller diameter and fits inside the larger bar. The larger of the two bars is generally fitted with a rubber grip. This grip is intended to prevent slippage when the apparatus is being used. The diameter of the larger bar can ideally be about two to three inches. The smaller of the bars should extend and retract within the larger bar thus making the total length of the vertical telescoping bar variable.

The smaller bar is then configured to be extended or retracted by the extension and retraction module. This module may be comprised of a mechanical crankshaft which is operated manually, a pneumatic actuator, an electric motor, or a detent mechanism. These examples are intended to illustrate the nature of the extension or retraction module. One skilled in the art would recognize any device intended to extend or retract a telescoping bar could be used as the extension and retraction module. Thus, the apparatus is intended to be extended with one end on the floor and the other extended to fit flush against the ceiling. After the vertical telescoping bar has been extended so that it is sufficiently secured between the floor and ceiling, it may be used as a support rail or grab bar.

The end-caps, which are fitted to the top and bottom of the vertical telescoping bar, are formed from a soft plastic or rubber material to prevent damage to the ceiling or floor of the dwelling where the apparatus is being used. In a preferred embodiment, the diameter of the end-caps is larger than the diameter of the vertical telescoping bar, therefore being able to distribute force from or on the extended vertical telescoping pole across a larger area on contract surfaces (e.g., floors and ceilings). Ideally, the diameter of the end caps is greater than two inches and can be as large, or larger than, one foot in diameter. In this way the pressure on contact surfaces is decreased with increased end cap diameters, thereby allowing the apparatus to be firmly secured between the floor and ceiling without damaging either surface. In addition, the outer surfaces of the end-caps are formed to have cleats or dimples intended to prevent the apparatus from slipping along the floor or ceiling surfaces during use.

Finally, the apparatus or system may include two separate vertical telescoping units used in conjunction to hold a third horizontal pull up bar. In this embodiment the apparatus may be set up over a bed or any other place where one may need aid in rising from a laying position. The horizontal pull up bar is locked between the two vertical telescoping bars via a locking module. Ideally, the horizontal bar can vary in diameter from approximately 1 to 3 inches.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a side view of a portable medical balance and support bar, which can be implemented in accordance with features of the present invention;

FIG. 2 illustrates an exploded view of the expansion and retraction module comprised of a crank, which can be implemented in accordance with another feature of the present invention;

FIG. 3 illustrates an exploded view of the expansion and retraction module comprised of a pneumatic actuator, which can be implemented in accordance with yet another feature of the present invention;

FIG. 4 illustrates an exploded view of the expansion and retraction module comprised of an electric motor, which can be implemented in accordance with yet another feature of the present invention;

FIG. 5 illustrates a side view of a portable medical balance and support bar with an extension and contraction module configured of an electric motor and associated power cord, which can be implemented in accordance with yet another feature of the present invention;

FIG. 6 illustrates an exploded view of the expansion and retraction module comprised of a detent mechanism, which can be implemented in accordance with yet another feature of the present invention;

FIG. 7 illustrates an exploded side view of a vertical telescoping bar fitted with a grip, which can be implemented in accordance with yet another feature of the present invention;

FIG. 8 illustrates an exploded perspective view of an end-cap formed to include a plurality of cleats, which can be implemented in accordance with yet another feature of the present invention;

FIG. 9 illustrates an exploded perspective view of an end-cap formed to include a plurality of dimples, which can be implemented in accordance with yet another feature of the present invention;

FIG. 10 illustrates a side view of a portable medical balance and support bar configured to include a horizontal pull up bar locked to the vertical telescoping bars by a locking module, which can be implemented in accordance with providing a system in accordance with features of the present invention.

FIG. 11 illustrates an exploded side view of a locking module and horizontal pull up bar connected to the vertical telescoping bar, which can be implemented in accordance with features for a system in accordance with features of the present invention.

### DETAILED DESCRIPTION OF THE INVENTION

The particular values and configurations discussed in these non-limiting examples can be varied and are cited merely to illustrate at least one embodiment of the present invention and are not intended to limit the scope of the invention.

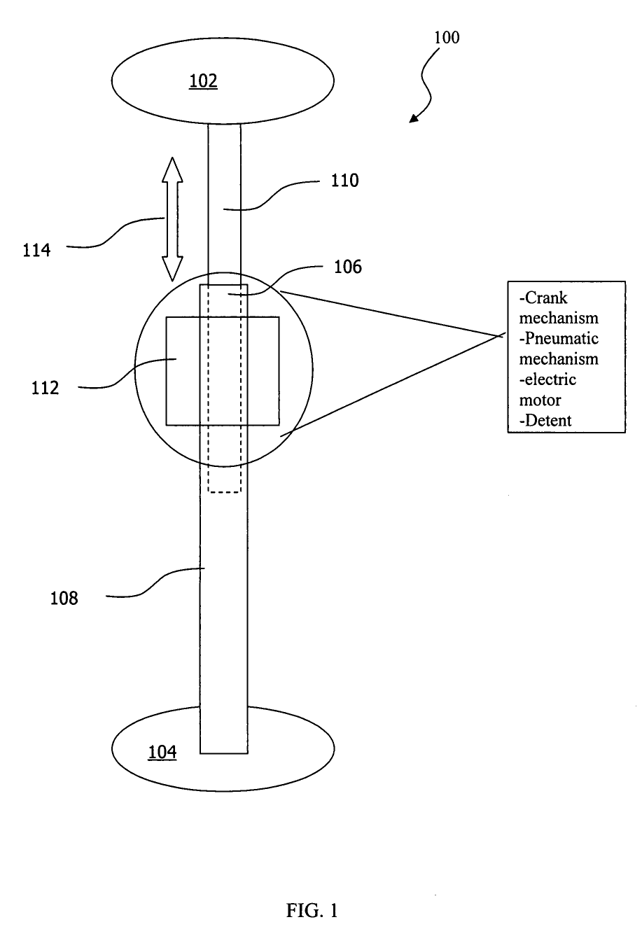

FIG. 1 illustrates a side view of a portable medical balance and support apparatus 100 in accordance with features of the present invention. The portable medical balance and support apparatus 100 generally includes a vertical telescoping bar 106, upon which end caps 102 and 104 are mounted on both ends. In addition, the portable medical balance and support apparatus 100 is configured to include an extension and retraction module 112 which is used to extend or contract vertical telescoping bar 106 in accordance with the motion described by arrow 114. The vertical telescoping bar is further comprised of two bars. The bar with the smaller diameter 110, fits inside the bar with the larger diameter 108. This allows bar 110 to extend and retract within bar 108. This arrangement allows for a single “telescoping” bar 106.

The term “telescoping” is commonly referred to in the art to describe a pole or bar that extends by fitting a series of thinner bars inside each other. For example, consider Dahlgren (U.S. Pat. No. 4,600,980) which discloses a “telescoping mast”. In a preferred embodiment, vertical telescoping bar 106 is made of metal to ensure it is strong enough to withstand significant strain during use. However, any strong lightweight material could be used to fabricate vertical telescoping bar 106.

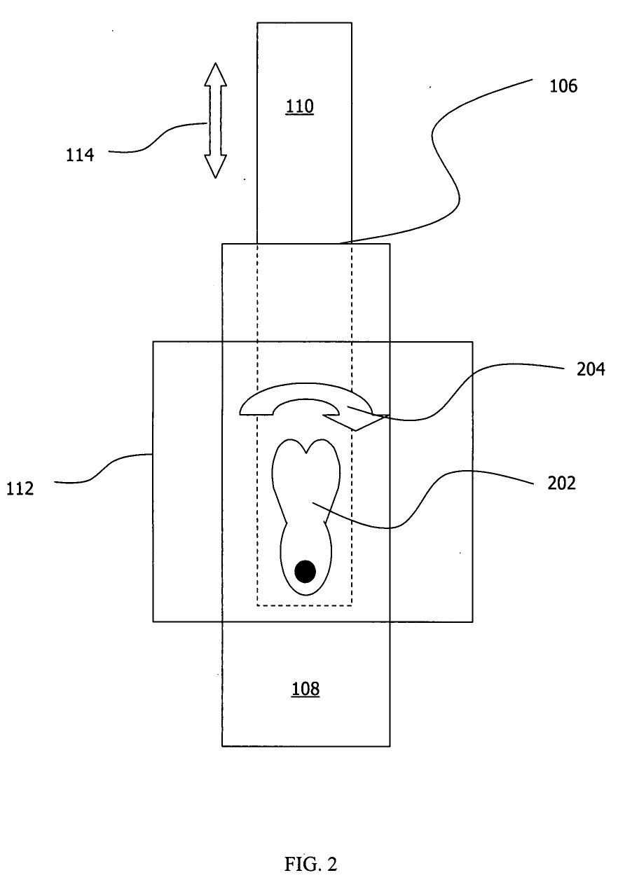

FIG. 2 illustrates an exploded view of extension and retraction module 112 further comprised of a crank 202, which may be implemented in accordance with features of the present invention. Crank 202 is manually turned in accordance with arrow 204. Crank 202 is used to extended or retract telescoping bar 106 in accordance with arrow 114. Crank 202 is preferably located above the center of bar 108 so that it is located in a place where it will not interfere with the primary function of the bar as a safety or grab bar.

Cranks generally are used to convert linear motion to rotational motion or vice versa. In the present apparatus turning crank 202 in one direction extends vertical telescoping bar 106 and when crank 202 is turned in the other direction vertical telescoping bar 106 is retracted. Cranks may be constructed of any number of materials. In the present invention it is especially important crank 202 be fabricated from a material that is lightweight to facilitate convenient transportation of the apparatus around the house.

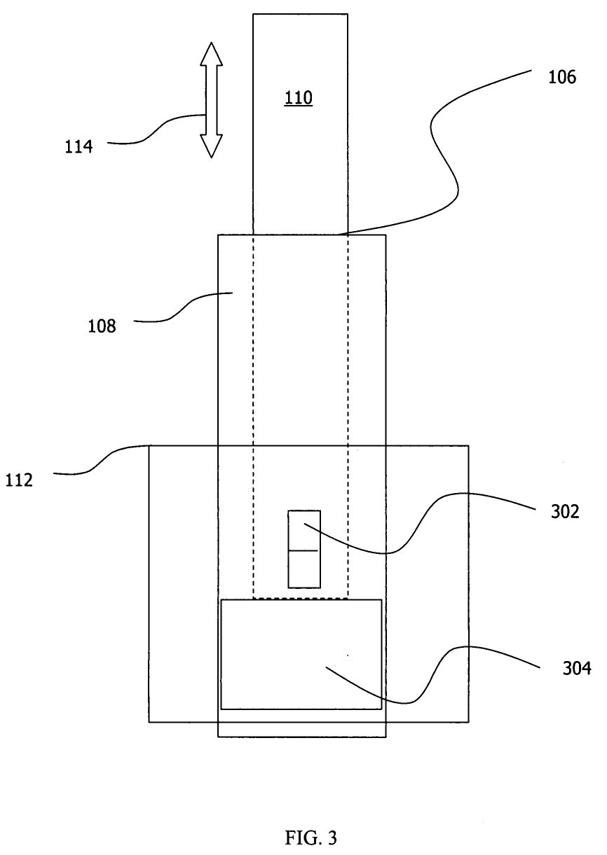

FIG. 3 illustrates an exploded view of extension and retraction module 112 further comprised of a pneumatic actuator 304, which may be implemented in accordance with a feature of the present invention. pneumatic actuator 304 is operated by switch 302 located externally on bar 108. The pneumatic actuator 304 is used to extend or retract telescoping bar 106 in accordance with arrow 114. Switch 302 is preferably located above the center of bar 108 as well.

Pneumatic devices are typically used to convert energy stored in the form of compressed air to mechanical energy. Pneumatic components offer a relatively high power to weight ratio. This is a particularly important feature of the present invention as convenient mobility is one key innovative feature. It is also important that extension and contraction module 112 be capable of supplying enough force to sufficiently secure the apparatus 100 between the floor and the ceiling so that it won't slip during use. Pneumatic actuator 304 serves both of these needs.

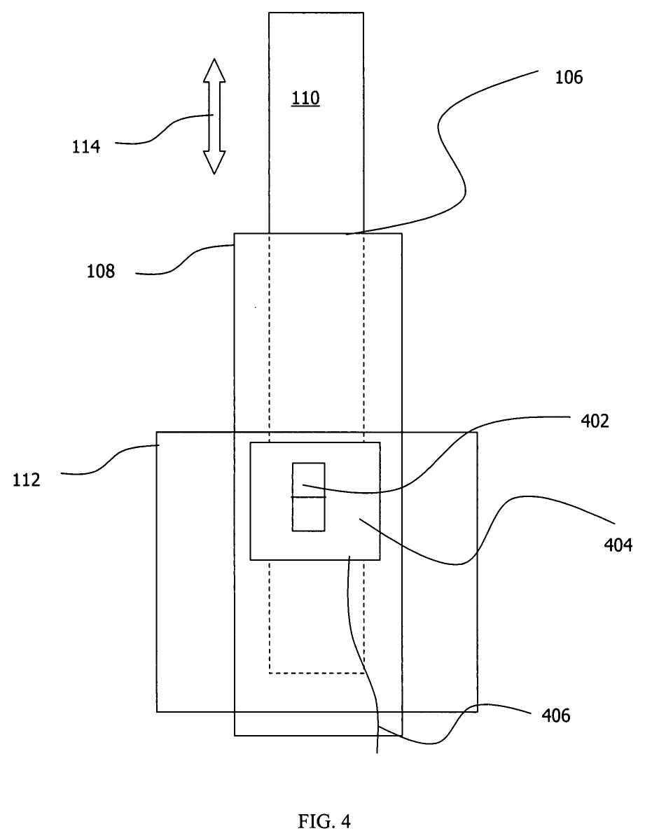

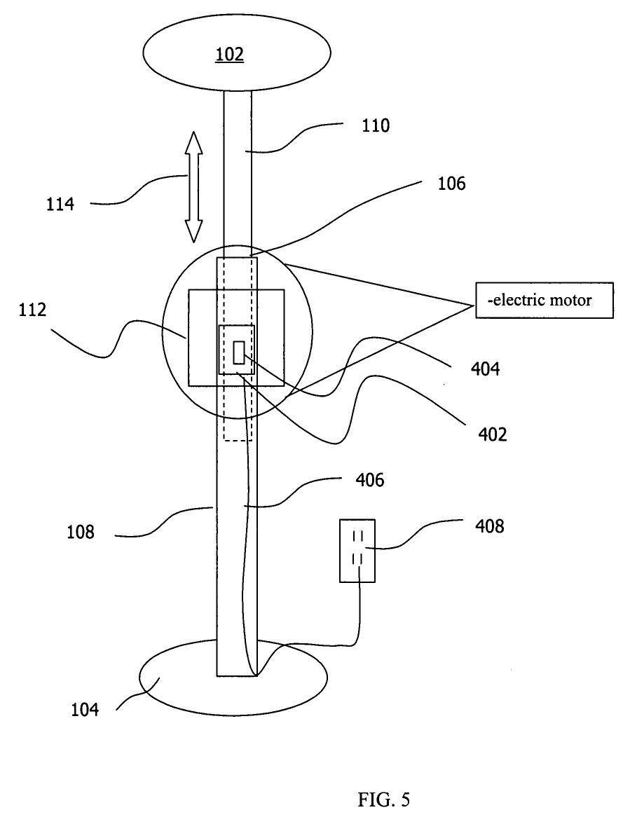

FIG. 4 illustrates an exploded view of extension and retraction module 112 further comprised of an electric motor 404, which may be implemented in accordance with yet another feature of the present invention. Electric motor 404 is operated by switch 402 located externally on bar 108. The electric motor is used to extend or retract telescoping bar 106 in accordance with arrow 114. Necessary to the operation of electric motor 404 is a source of power. Power cord 406 is illustrated as a means for delivering power to electric motor 404. FIG. 5 further illustrates portable medical balance and support apparatus 100 configured with electric motor 404 and connected via power cord 406 to power source 408.

Electric motors are readily commercially available and any such motor with the necessary size and power requirements may be used in the implementation of one embodiment of the present invention. Further, such motors are generally inexpensive.

Use of the electric motor as the extension and retraction module offers one significant advantage over other features for extension/extraction module 112 of the present invention. In some cases the person using the poles may suffer from a physical condition that makes manual operation, of a crank for example, to extend or retract the apparatus difficult or impossible. However, an electric motor requires only operation of a switch to extend or retract vertical telescoping bar 106 which may prove drastically more convenient for some users.

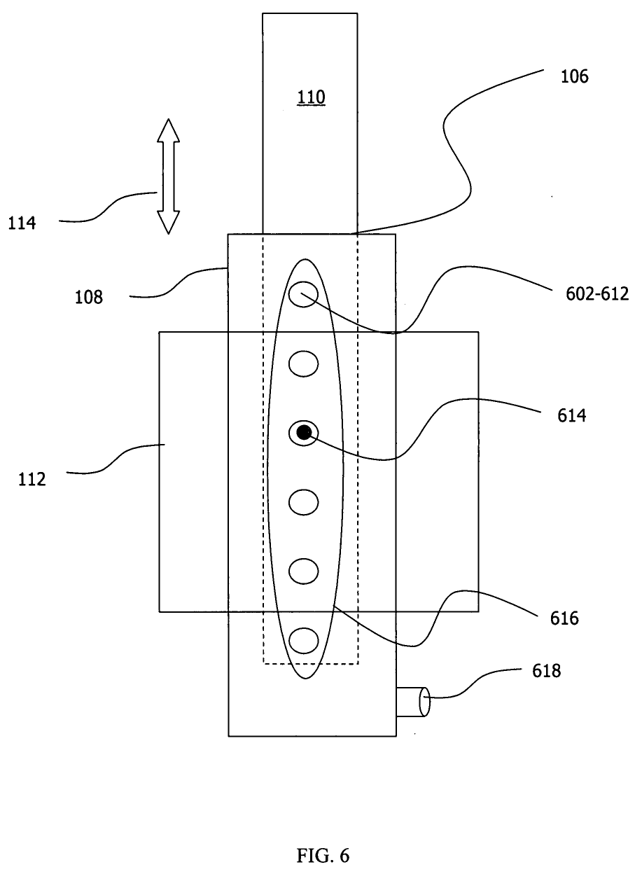

FIG. 6 illustrates an exploded view of extension and retraction module 112 further comprised of a detent mechanism 616. Detent mechanism 616 is further comprised of a plurality of holes 502-512 located on the exterior of bar 108 and a button 514 located on the exterior of bar 110. Button 514 is preferentially spring loaded so that it may be depressed and subsequently slid through the inner surface of bar 108 in accordance with arrow 114 until it reaches one of the plurality of holes 502-512 at which time it is extended through the hole locking vertical bar 106 in place until the button 514 is depressed again and the process repeated.

Detent mechanisms are commonly used in telescoping components and offer several advantages over other extension and retraction methods. First, the manipulation of button 614 is relatively simple and not physically strenuous. In addition, the components are very light weight making the apparatus more convenient to tote. Finally, the cost of manufacturing the parts to make a detent mechanism is relatively low. Therefore, in a preferred embodiment of the present invention a detent mechanism is used to extend and retract the apparatus 100.

Detent mechanism 616 also includes fine tune adjustment 618. Detent mechanisms generally are limited to discrete lengths based on the distance between the plurality of holes 502-512. Thus, in some instances it would be very difficult to adjust the height of the portable medical support and balance apparatus 100 properly. In order to correct for this problem, a fine tune adjustment 618 is used. When fine tune adjustment 618 is turned the length of telescoping bar 106 is increased or decreased slowly by a maximum of the distance between any two of the plurality of holes 502-512. The user may now adjust the length of the telescoping bar to lengths in between the discreet lengths defined by the plurality of holes 502-512.

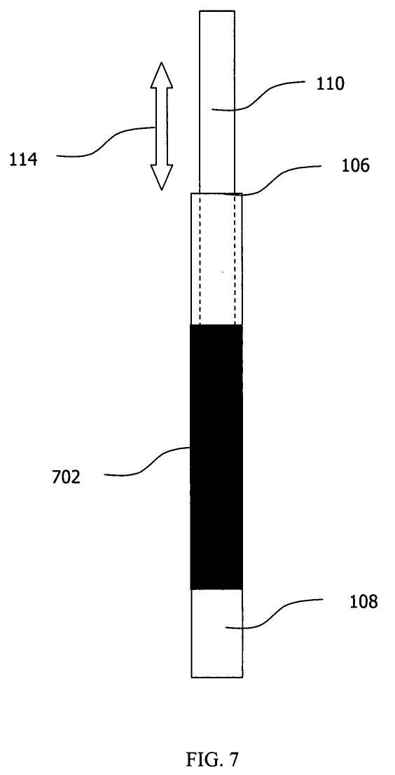

FIG. 7 illustrates vertical telescoping bar 106 fitted with grip 702. Grip 702 is located on the exterior of bar 108 in order to offer a surface less prone to slippage when a user is gripping the apparatus. In a preferred embodiment, grip 702 is made of rubber plastic or any other material suitable for improving a users grip on vertical telescoping bar 106.

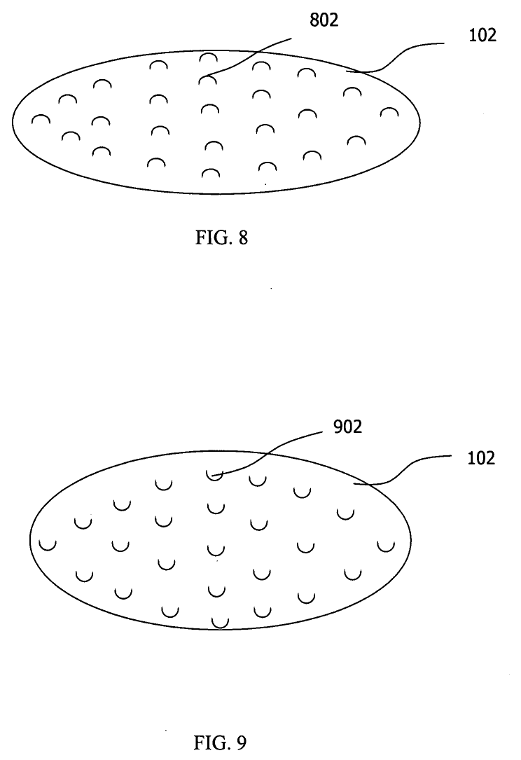

FIG. 8 illustrates a perspective view of end-cap 102 or 104. In FIG. 8 end-cap 102 or 104 is further formed to include a plurality of cleats 802. These cleats 802 are intended to prevent apparatus 100 from slipping when engaged against the ceiling or floor. FIG. 9 similarly illustrates end cap 102 or 104 configured with dimples 902 rather than cleats. Dimples 902 are similarly intended to prevent apparatus 100 from slipping when engaged against a ceiling or floor.

In selecting the material used to make end-cap 102 or 104 it is important to use something that not only will prevent slippage but will also not damage the roof or ceiling where the apparatus 100 is placed. Therefore, the material used to manufacture end-cap 102 or 104 should be rubber, plastic, or some other lightweight material. In a preferred embodiment the material chosen should also be clear to prevent leaving scuffs on the floor or ceiling after apparatus 100 is removed.

In addition it is important to consider the size of end-cap 102 or 104. The pressure placed on the floor and ceiling by the extension of vertical telescoping bar 106 will necessarily be relatively large so that the apparatus will not be pulled or pushed out of place during use. This high pressure is likely to cause damage to the ceiling or floor if the diameter of end-cap 102 or 104 is not sufficiently large enough to distribute this force and decrease the overall pressure on the floor and ceiling. Therefore, in a preferred embodiment end-cap 102 or 104 is manufactured to be larger than the diameter of the telescoping bar, which is ideally two to three inches in diameter, and can be provided at up to at least one foot or more in diameter. Larger diameter end caps help distribute pressure over the surface areas of the ceiling and flooring.

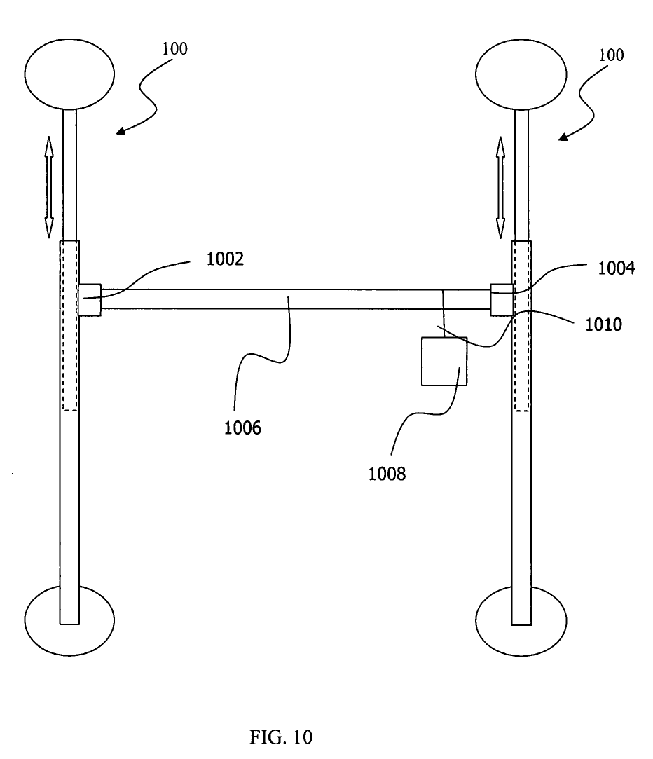

FIG. 10 illustrates one aspect of the present invention 900. Two portable medical balance and support apparatuses are used in conjunction to hold a third horizontal pull up bar 1006 to provide for a system. Horizontal pull up bar 1006 is secured to bar 108 via a locking module 1002 or 1004.

Embodiment system in accordance with features of the present invention is intended to provide a portable grab bar across, for instance, a bed where a person may require a support bar to incline from a prostrate position to a sitting or standing position. This embodiment may be further utilized in any situation where a horizontal rather than vertical grab bar or safety rail is required. In addition, FIG. 10 illustrates hanging device 1010 which may be attached to horizontal pull up bar 1006 to hang any number of medical devices such as medical device 1008. It would be realized by one skilled in the art that a plurality of medical devices, and hanging devices like 1010, may be utilized in accordance with the present invention.

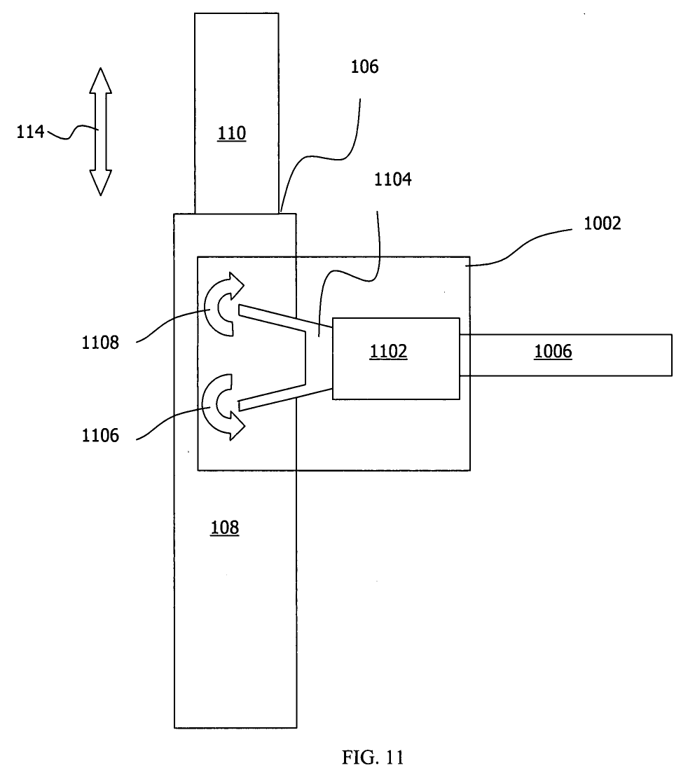

FIG. 11 illustrates an exploded view of locking module 1002, in accordance with implementing features of the present invention. Locking device 1104 is configured to open outwardly as depicted by arrows 1106 and 1108 when sheath 1102 is retracted. In this way locking device 1104 is inserted into bar 108 and then sheath 1102 is retracted to open the fingers of locking device 1104 and lock bar 1006 in place. It would be appreciated by one skilled in the art that this represents one example of a locking mechanism that could be implemented as locking module 1002, and that any locking mechanism known in the art might be used in accordance with an alternative embodiment of the present invention.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered.

The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

The embodiments of the invention in which an exclusive property or right is claimed are defined as follows. Having thus described the invention what is claimed is:

1. A portable medical balance and support bar, comprising:
a telescoping bar including an inner bar adjustable within an outer bar;
end-caps coupled to each end of said telescoping bar; and
an extension and retraction module adapted to adjust said telescoping bar by extending or retracting said inner bar within said outer bar, thereby allowing said portable medical balance and support bar to be securely fitted between a floor and a ceiling of a user environment to aid a user in maneuvering around the environment.

2. The portable medical balance and support bar of claim 1 wherein said extension and contraction module is comprised of a crank mechanism.

3. The portable medical balance and support bar of claim 1 Wherein said extension and contraction module is comprised of a pneumatic actuator.

4. The portable medical balance and support bar of claim 1 wherein said extension and contraction module is comprised of an electric motor.

5. The portable medical balance and support bar of claim 1 wherein said extension and retraction module is comprised of a detent mechanism.

6. The portable medical balance and support bar of claim 1 wherein said end-caps are constructed of a soft plastic or rubber material thereby preventing damage to the surface said end caps are compressed against.

7. The portable medical balance and support bar of claim 1 wherein said end-caps are formed to include cleats to prevent said portable medical support bar from slipping or becoming dislodged during use.

8. The portable medical balance and support bar of claim 1 wherein said end-caps are formed to include dimples to prevent said portable medical support bar from slipping or becoming dislodged during use.

9. The portable medical balance and support bar of claim 1 wherein said outer bar has an outer surface, said portable medical balance and support bar further comprising fitted soft grip material adhered to said outer surface thereby improving a users ability to grip said portable medical support bar without slipping.

10. A portable medical balance and support system, comprising:
at least one vertical telescoping bar including an inner bar adapted to be adjustable within an outer bar having an outer surface, said at least one vertical telescoping bar fitted with end-caps adapted to secure said at least one vertical telescoping bar between the ceiling and floor of a dwelling;
at least one extension and retraction module wherein at least one of said extension and retraction modules is integrated with said at least one telescoping bar to enable said inner bar to be extended and retracted within said outer bar;
soft grip material fitted to said outer surface of said outer bar thereby improving a user ability to grip said at least one telescoping bar without slipping.

11. The portable medical balance and support system of claim 10 wherein said at least one extension and retraction module is further comprised of a crank.

12. The portable medical balance and support system of claim 10 wherein said at least one extension and retraction modules are further comprised of a pneumatic actuator.

13. The portable medical balance and support system of claim 10 wherein said at least one extension and retraction modules are further comprised of an electric motor.

14. The portable medical balance and support system of claim 10 wherein said at least one extension and retraction modules are further comprised of a detent mechanism.

15. The portable medical balance and support system of claim 10 further comprising a horizontal pull up rail secured between at least two vertical telescoping bars.

16. The system of claim 15 further comprising a locking module adapted to lock said pull up rail to said at least two of said plurality of vertical telescoping bars together.

17. The system of claim 10 wherein said end-caps are formed of dimpled or cleated soft rubber or plastic.

18. A portable medical balance and support system, comprising:
a set of vertical telescoping bars fitted on both ends with at least two soft rubber end-caps;
at least one extension and retraction module used to extend or retract said at least one of said set of vertical telescoping bars fitted on both ends with said soft rubber end-caps;
a horizontal pull up rail configured to connect to at least two of said vertical telescoping bars;
at least two locking modules used to secure said horizontal pull up rail to at least two of said vertical telescoping bars;
a plurality of soft grips fitted to at least one of said vertical telescoping bars and said horizontal pull up rail;
wherein said set of vertical telescoping bars are fitted on both ends with said soft rubber end-caps and said extension and retraction modules are used to extend or retract at least one of said set of vertical telescoping bars so said bars are securely fitted between the ceiling and floor of a dwelling; and wherein said horizontal pull up rail is locked between said set of vertical telescoping bars and locked in position by said set of locking modules.

19. The system of claim 18 further including a plurality of hanging connectors connected to said horizontal pull up rail whereby a user may hang medical equipment to said horizontal pull up rail.
